(19) United States
(12) Patent Application Publication
(10) Pub. No.: US 2006/0114256 A1
(43) Pub. Date: Jun. 1, 2006

(54) Image display apparatus, displaying method, and recording medium having display program for the image display apparatus recorded therein

(76) Inventor: Tomomi Kaminaga, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/288,544

(22) Filed: Nov. 29, 2005

(30) Foreign Application Priority Data
Nov. 29, 2004 (JP) 2004-344223
Nov. 4, 2005 (JP) 2005-321057

(51) Int. Cl. G06T 11/20

(52) U.S. Cl. 345/440

(57) ABSTRACT

An image display apparatus according to the present invention is provided for displaying a year circle as the time circle which indicates a predetermined length of time on the screen of its display unit. When the indicator at desired one of years provided on the year circle is selected and clicked by a mouse, the year circle appears with its center coinciding the indicator. Simultaneously, groups of small sized images recorded in the year are displayed at their corresponding recorded month indications on the year circle.

### CROSS-REFERENCE TO RELATED APPLICATIONS

This application is based upon and claims the benefit of priority from prior Japanese Patent Applications No. 2004-344223, filed Nov. 29, 2004; and No. 2005-321057, filed Nov. 4, 2005, the entire contents of both of which are incorporated herein by reference.

### BACKGROUND OF THE INVENTION

1. Field of the Invention

The present invention relates to an image display apparatus for displaying a plurality of images simultaneously, a displaying method, and a recording medium having a display program for the image display apparatus recorded therein.

2. Description of the Related Art

As a plurality of picture images have commonly been recorded in a recording medium such as a flash memory, a hard disk drive, or a digital versatile disk (DVD), they are now saved at greater volumes in a single mass-storage medium of which the recording density is increased due to advances in the relevant technology. It is hence essential to retrieve desired picture images at higher efficiency from the mass-storage medium where a huge volume of image data is saved.

One of the related arts for retrieving desired picture images at higher efficiency is known in which the picture images are downsized to data compressed images also called thumb nail images and displayed in, for example, a 3×3=9 format.

However, the related art permits a plurality of picture images to be displayed in the same sequence as when recorded onto a recording medium. When a desired image has been recorded at or close to the last onto the recording medium, it is received only with a boring consumption of time. In addition, their retrieving operation is not so troublesome when the number of recorded images is about some tens but shall consume a considerable length of time when the number is some hundreds or more. As a result, the operation of retrieving the desired images will be declined in the readiness of operation.

An attempt is then proposed for retrieving and displaying images on the block-by-block basis but not one-by-one. In particular, the operation of retrieving picture images depends generally on the date of shooting. There are developed a variety of methods for displaying groups of picture images reduced in the size and identified with their shooting date including year, month, and date.

As disclosed in Jpn. Pat. Appln. KOKAI Publication No. 11-215457, one of the methods for displaying the picture images in a calendar-like form is known where any desired image can be searched through viewing pages of the calendar.

Also, disclosed in Jpn. Pat. Appln. KOKAI Publication No. 2003-228587 is a retrieving apparatus for displaying picture images in a size reduced form aligned on the time basis of year, month, and date and allowing the display to be switched between a large time interval and a small time interval.

Another retrieving and displaying apparatus is disclosed in Jpn. Pat. Appln. KOKAI Publication No. 2004-38698 where a season setting indicator is displaced in the form of a rotary disk as fitted onto one at the current year of shooting year setting bars.

A further method is disclosed in Jpn. Pat. Appln. KOKAI Publication No. 2003-331258 which includes displaying a retrieving range along the time axis so that, when a desired part of the retrieving range is selected as a main area to be examined, its display is separately made from the other areas to exhibit a group of images in each interval in the form of a bar graph.

A still further method is disclosed in Jpn. Pat. Appln. KOKAI Publication No. 2001-351127 where a data of interest is displayed in a virtual space determined by the user from information assigned with the data so as to be perceived intuitively at a moment in a data display system. More specifically, as a number of circles, each indicating one year in the full turn, are displayed, its location representing each month carries images to be retrieved.

As disclosed in the Jpn. Pat. Appln. KOKAI Publication Nos. 11-215457, 2003-228587, 2004-38698, 2003-331258, and 2001-351127, there have been proposed a variety of such methods of displaying some representatives of the picture images along the time axis and allowing desired images to be retrieved through examining time intervals along the time axis.

The method of retrieving desired picture images involves different modes of the time axis including year, month, week, and date. It is hence essential for improving the efficiency of actual operation to smoothly switch the display from one time axis to another.

### BRIEF SUMMARY OF THE INVENTION

It is an object of the present invention to provide an image display apparatus, a displaying method and a recording medium for saving the display program which are arranged for retrieving desired ones of picture images with much ease.

A first aspect of the present invention is to provide an image display apparatus including:

a time display unit which displays a time circle which is a circular time axis indicating a predetermined length of time in the full turn; and

an image display unit which displays groups of small sized images, which have been recorded at intervals of time in the time circle, at the locations assigned to the intervals of the time circle, wherein

when one of the intervals of time on the time circle is specified, the time display unit displays another time circle which indicates the specified interval of time as a full length of time and of which the center is at the specified interval of time, and

the image display unit displays corresponding ones of the small sized images along the another time circle.

A second aspect of the present invention is to provide a displaying method for an image display apparatus, including:

displaying a time circle which is a circular time axis indicating a predetermined length of time in the full turn;

displaying groups of small sized images, which have been recorded at intervals of time in the time circle, at the locations assigned to the intervals of the time circle;

when one of the intervals of time on the time circle is specified, displaying another time circle which indicates the specified interval of time as a full length of time and of which the center is at the specified interval of time; and

displaying corresponding ones of the small sized images along the another time circle.

A third aspect of the present invention is to provide a computer-readable recording medium having recorded therein a program to cause a computer to execute a displaying method on an image display apparatus, wherein

the display method includes:

displaying a time circle which is a circular time axis indicating a predetermined length of time in the full turn;

displaying groups of small sized images, which have been recorded at intervals of time in the time circle, at the locations assigned to the intervals of the time circle;

when one of the intervals of time on the time circle is specified, displaying another time circle which indicates the specified interval of time as a full length of time and of which the center is at the specified interval of time; and

displaying corresponding ones of the small sized images along the another time circle.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a fundamental structure of an image display apparatus showing a first embodiment of the present invention;

FIG. 2 is a flowchart illustrating the operation of displaying a retrieving screen on the image display apparatus according to the first embodiment of the invention;

FIG. 3 illustrates a year circle on the initial retrieving screen on the image display apparatus according to the first embodiment of the invention;

FIG. 4 illustrates the year circle overlapped with a month circle on another retrieving screen on the image display apparatus according to the first embodiment of the invention;

FIG. 5 illustrates the month circle, at the center, overlapped with the year circle on a further retrieving screen on the image display apparatus according to the first embodiment of the invention;

FIG. 6 illustrates the month circle, at the center, overlapped with the year circle and a date circle on a further retrieving screen on the image display apparatus according to the first embodiment of the invention;

FIG. 7 illustrates the date circle, at the center, overlapped with the month circle on a further retrieving screen on the image display apparatus according to the first embodiment of the invention;

FIG. 8 illustrates an hour circle, at the center, overlapped with the date circle and the month circle on a further retrieving screen on the image display apparatus according to the first embodiment of the invention;

FIG. 9 illustrates all the four time circles ranging from the year circle to the hour circle on a further retrieving screen on the image display apparatus according to the first embodiment of the invention;

FIG. 10 illustrates groups of small sized images for a slide show allocated along a circumferential edge of an hour circle 51, showing a second embodiment of the present invention;

FIG. 11 is a flowchart showing a procedure of the slide show on an image display apparatus according to the second embodiment of the invention;

FIG. 12 is a flowchart showing a sub routine of “determining the size of images to be displayed” carried out in step S21 in the flowchart of FIG. 11;

FIG. 13 is a table showing the relationship between the image number and the counter setting in the operation of the slide show on the image display apparatus according to the second embodiment of the invention;

FIG. 14 is a table showing the relationship between the counter setting st and the parameter r for determining the size of images to be displayed in the operation of the slide show on the image display apparatus according to the second embodiment of the invention; and

FIG. 15 illustrates an example of display explaining the operation of the slide shown on the image display apparatus according to the second embodiment of the invention.

### DETAILED DESCRIPTION OF THE INVENTION

Embodiments of the present invention will be described in more detail with reference to the accompanying drawings.

### First Embodiment

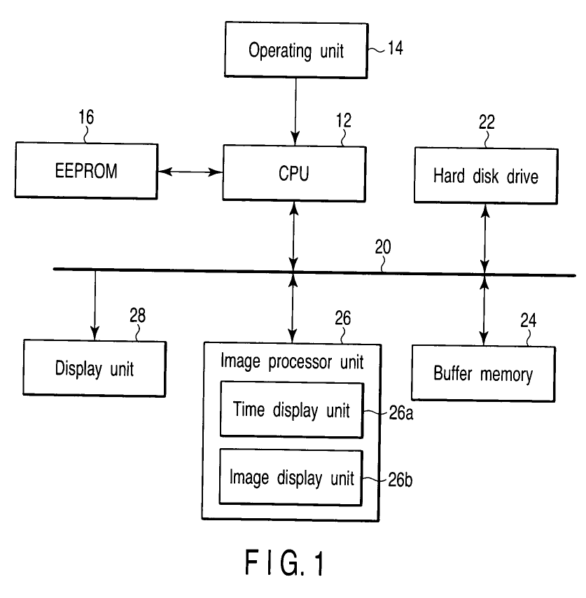

FIG. 1 is a block diagram of a fundamental structure of an image displaying apparatus, showing a first embodiment of the present invention.

As shown in FIG. 1, a central processing unit (CPU) 12 is provided as the display controller for controlling the entire operation of the image displaying apparatus. The CPU 12 is connected with an operating unit 14 such as a mouse, a keyboard, a touch panel, or an array of switches for input of commands and an EEPROM 16 which is a recording medium in which control programs for operating the image displaying apparatus are stored. The CPU 12 is also connected via a bus 20 with a hard disk drive 22, a buffer memory 24, an image processor unit 26, and a display unit 28.

The hard disk drive 22 incorporates image data storage for saving a plurality of picture images. The buffer memory 24 is configured to start an operation of processing the images read out from the hard disk drive 22.

The image processor unit 26 is an image processing means for conducting processes as y correction and data expansion of the images to be displayed on the display unit 28 or the images read out from the hard disk drive 22 or held temporarily in the buffer memory 24.

The image processor unit 26 also includes a time display unit 26a for displaying a time axis indicating series of time intervals in the form of a time circle and an image display unit 26b for displaying the images shot or saved in a record. The display functions will be explained later in more detail.

The display unit 28 is provided for displaying the images processed by the image processor unit 26. The display unit 28 may be implemented by a LCD for instance.

It is assumed for ease of the description that the operating unit 14 is a mouse.

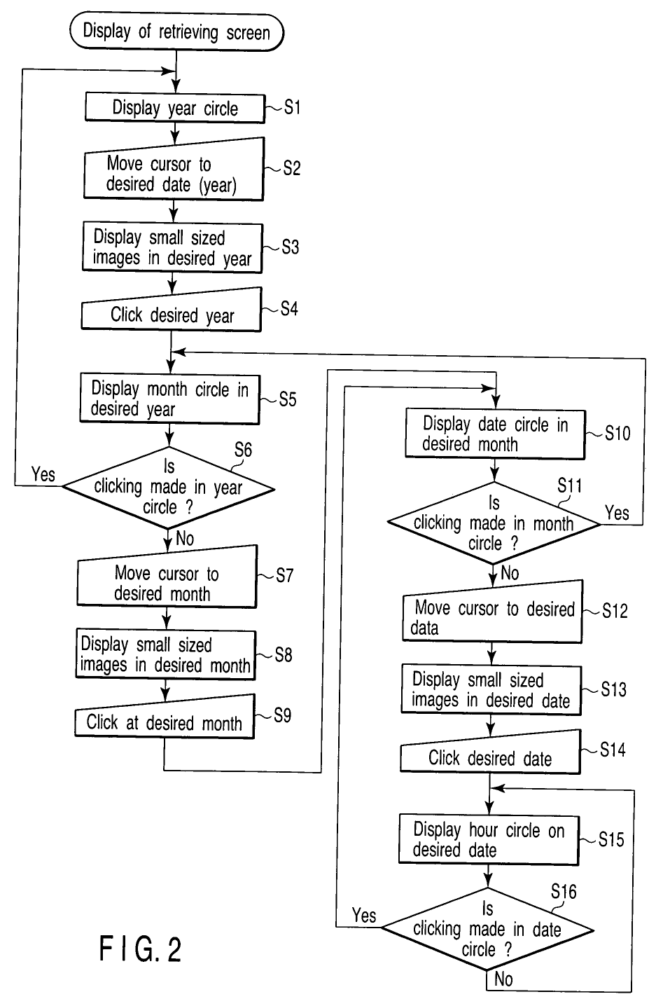

The procedure of retrieving desired images in the image displaying apparatus of the present invention will now be described referring to the flowchart of FIG. 2.

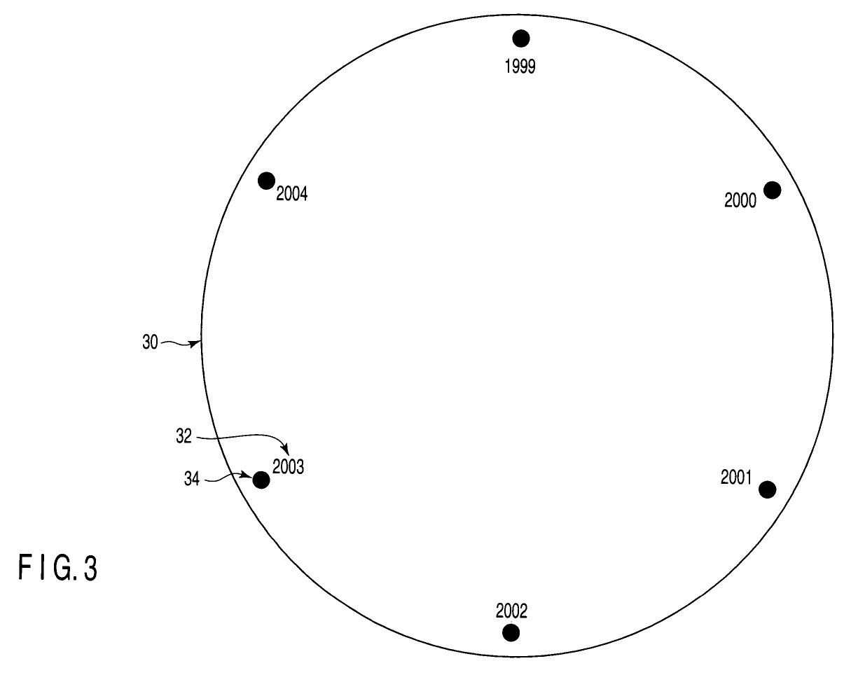

The procedure starts with step S1 for operating the mouse, not shown, on the operating unit 14 to display on the initial screen of the display unit 28 a year circle 30 which indicates a series of years in a time circle as shown in FIG. 3. The time circle is a circle-formed time axis indicating equal intervals of time in a full turn. The time circle is a general term and may be classified into year circle, month circle, date circle, and hour circle. These time circles are displayed by the time display unit 26a.

The year circle 30, as shown in FIG. 3 for example, indicates year indications 32 for six years, “1999”, “2000”, “2001”, “2002”, “2003”, and “2004”, at the periphery denoted by the numeral 32. The year indication 32 is accompanied with a plurality of indicators 34 as the target to be clicked with the mouse, which will be explained later. At this time, the initial screen of the display unit 28 displays no picture images.

Although a year circle of “1999” to “2004” is shown in FIG. 3, it is not limited to this, but may indicate another series of years which is switched from the preceding series by the operation of a dedicated switch, not shown, on the operating unit 14. Also, the series of years is not limited to six.

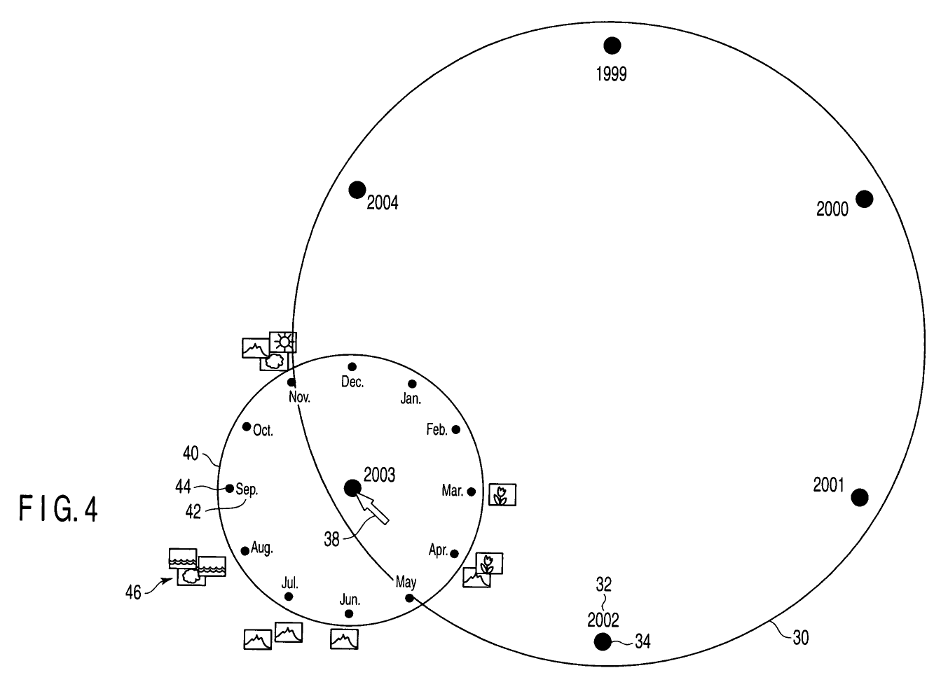

Then, step S2 follows for moving the cursor 38 to select a desired time (the year in this case) using the mouse (See FIG. 4). It is now assumed that the year indication 32 of “2003” is selected.

When the indicator 34 at the year has been selected with the cursor 38 and clicked by the operation of the mouse, it is detected by the CPU 12 that the year “2003” is selected. In step S3, the display is shifted from the initial screen shown in FIG. 3 to another screen such as shown in FIG. 4. The CPU 12 directs the display unit 28 to display a month circle 40 which is formed as a circle, with the time circle of the year as a new time circle, with the year pointed with the cursor 38 (at “2003”) at its center. The month circle 40 like the year circle 30 carries twelve month indications 42 from January denoted as “Jan” to December denoted as “Dec” and their respective indicators 44 provided at the proximity.

Simultaneously, groups of small-sized picture images 46 produced from their original size picture images are displayed at the outside of the circumferential edge of the month circle 40 at the locations corresponding to the date of shooting. All of the small sized images 46 may be displayed when their number remains within a predetermined limit number. If the total number of the small sized images 46 is greater than the limit number, they may be displayed by chronological order; for example, the oldest comes first. These small-sized picture images are displayed by the image display unit 26b.

As shown in FIG. 4, the year indicator (at “2003”) pointed by the cursor 38 is clicked by the operation of the mouse in step S4.

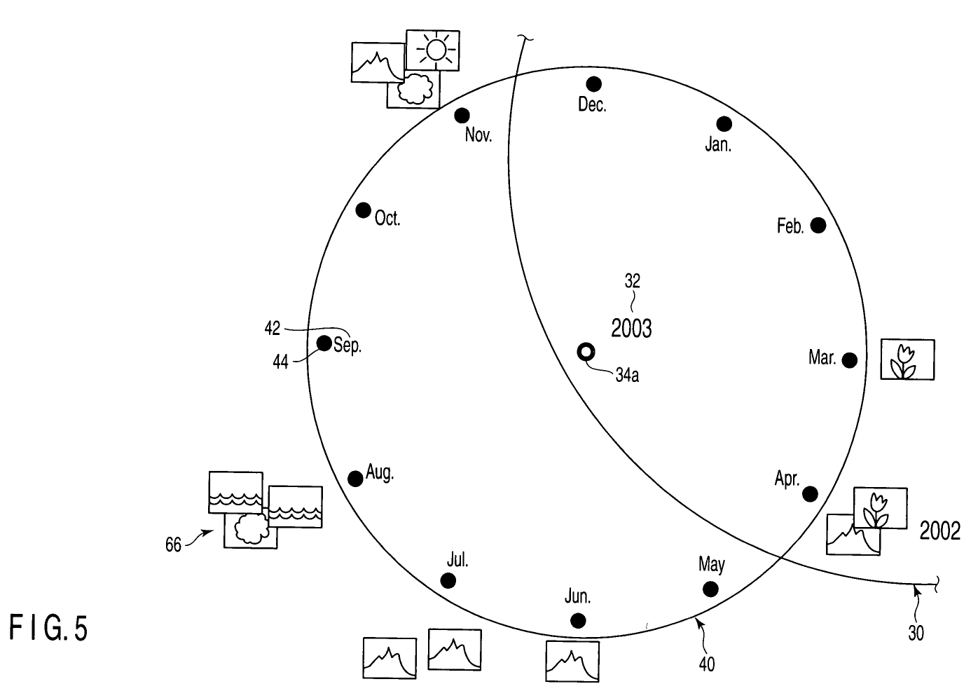

This is followed by step S5 in which the CPU 12 directs to display the month circuit 40 in a large scale at the center of the screen of the display unit 28 as shown in FIG. 5. Along with the enlarged display of the month circuit 40, groups of the small sized images 46 are displayed at a larger scale. At this time, the year indicator 34 of the year indication 32 is viewed in a partially inverted mode as has been clicked, as denoted by 34a.

While the month circle 40 is explicitly displayed at the center of the display as shown in FIG. 5, the year circle 30 may remain appearing in a faded or thin tone.

This is followed by step S6 for examining whether or not the year circle 30 that is displayed in a faded tone has been clicked as pointed out by the cursor 38. If not, the procedure advances to step S7. When it is determined in the step S6 that the year circle 30 has been clicked, the procedure goes back to the step S1 for displaying the initial screen where the year circle 30 is displayed at the center (See FIG. 3). The month circle 40 that is a lower level indication disappears.

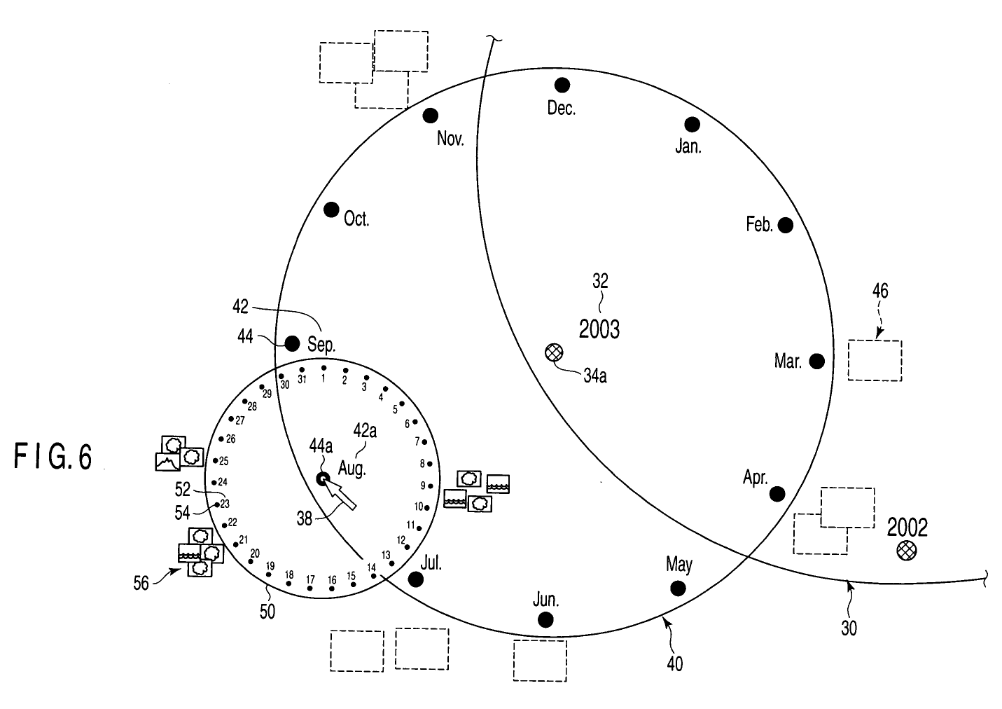

In step S7, it is supposed the cursor 38 is moved to a desired month in the month circle 40. It is assumed that the month indicator 44a at the month indication 42a of “Aug” representing August is selected as shown in FIG. 6.

Then, the CPU 12 in step S8 directs to display a date circle 50, as a new time circle of the month pointed with the cursor 38 (at “Aug”) with he month indicator 44a at the center. The date circle 50 like the year circle 30 and the month circle 40 carries thirty one date indications 52 from the first denoted as “1” to the thirty first denoted as “31” and their respective indicators 54 provided at the proximity.

Simultaneously, groups of the picture images in a smaller size 56 produced from their original size picture images are displayed at the outside of the circumferential edge of the date circle 50 on the display unit 28 at the locations corresponding to the date of shooting. All of the small sized images 56 may be displayed when their number remains within a predetermined limit number. Also, the small sized images 46 other than the images at the month selected with the cursor 38 may be displayed in a different mode. For example, they are displayed in a faded or thinner tone than those at the month (“Aug”). In FIG. 6, the small sized images 46 other than the images at the selected month are expressed by dotted lines. This allows the small sized images to be easily distinguished between the selected time interval (the month) and the other not selected time intervals.

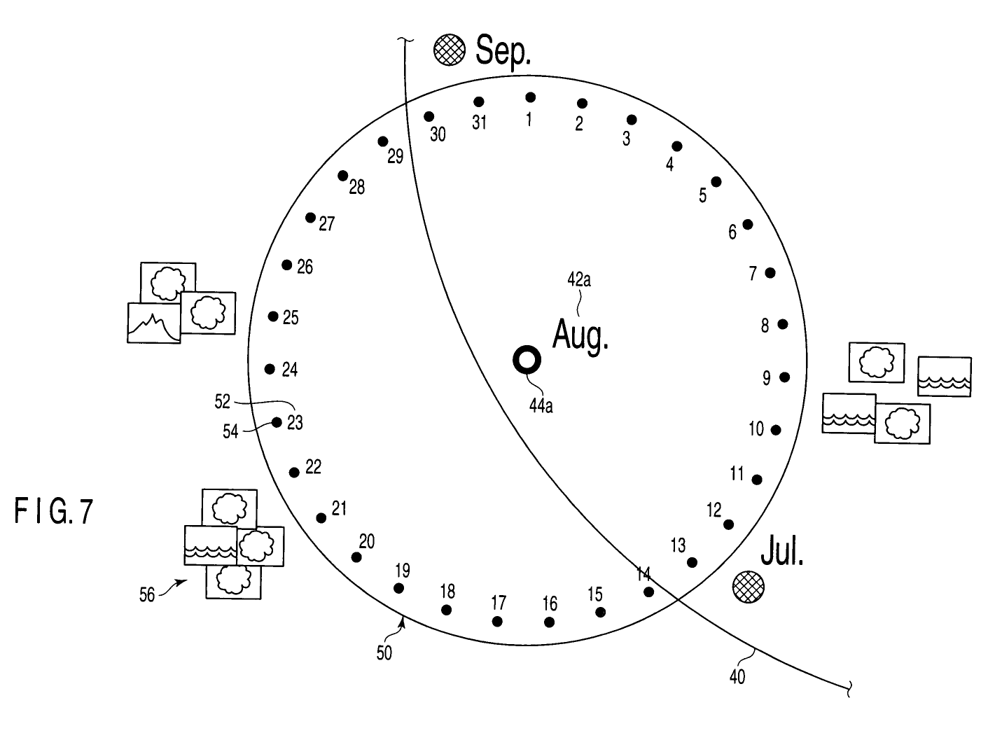

In step S9, the month (“Aug”) pointed out with the cursor 38 is clicked by the operation of the mouse. Then, the CPU 12 in step S10 directs to display the date circle 50 in a large scale at the center of the screen of the display unit 28 as shown in FIG. 7.

Along with the enlarged display of the date circuit 50, groups of the small sized images 56 at the outside of the circumferential edge of the date circle 50 are displayed at an enlarged scale. At the time, the month indicator 44 of the month indication 42a is viewed in a partially inverted mode as has been clicked, as denoted by 44a.

While the date circle 50 is explicitly displayed at the center of the display unit 28 as shown in FIG. 7, the month circle 40 may remain appearing in a faded or thin tone.

This is followed by step S11 for examining whether or not the month circle 40 has been clicked as pointed by the cursor 38. If not, the procedure advances to step S12. When it is determined in S11 that the month circle 40 has been clicked, the procedure goes back to step S5 for displaying the preceding screen where the month circle 40 is displayed at the center (See FIG. 5). The date circle 50 that is a lower level indication disappears.

In step S12, it is supposed the cursor 38 is moved to a desired date in the date circle 50. It is assumed that the date indicator 54 at the date indication 52 of “21” representing the twenty first of a month is selected although not shown. Then, the CPU 12 in step S13 directs to display an hour circle which is formed as a circle, as the time circle to indicate the date “21” pointed by the cursor 38 with the indicator 21 as the center (although not shown). The hour circle like the month circle 40 and the date circle 50 carries twenty four hour indications from the first denoted as “1” to the last denoted as “24” and their respective indicators provided at the proximity. Simultaneously, groups of the picture images in a smaller size produced from their original size picture images are displayed at the outside of the circumferential edge of the hour circle on the display unit 28 at the locations corresponding to the hour of shooting. All of the small sized images may be displayed all when their number remains within a predetermined limit number. Also, the other small sized images than the images at the hour selected with the cursor 38 may be displayed in a thinner tone than that of the date indication (“21” in the figure).

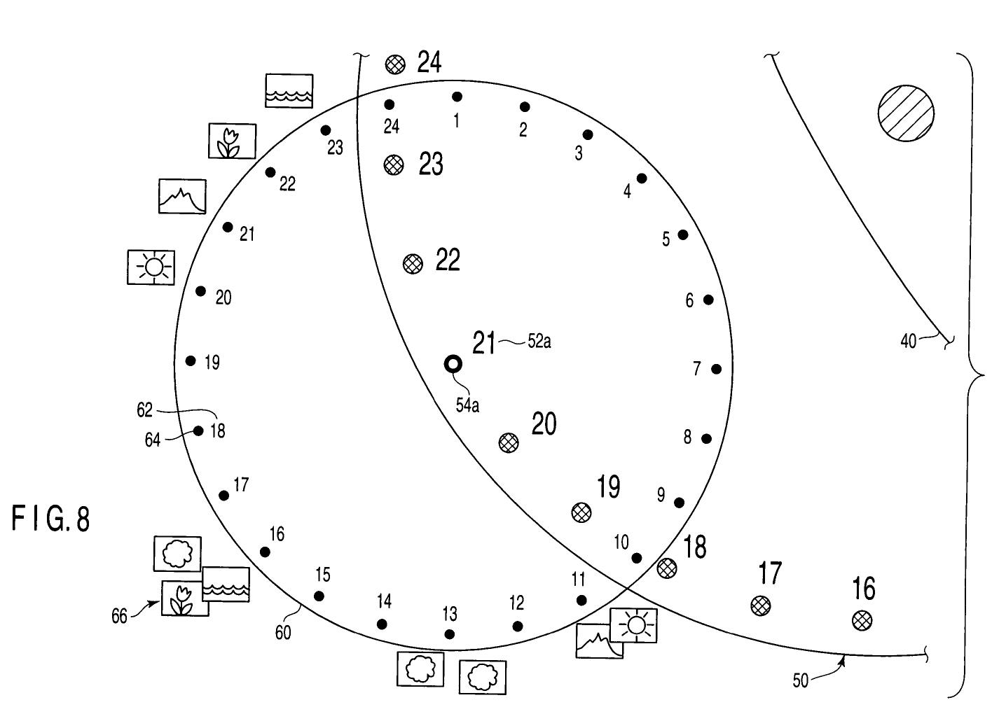

In step S14, the date (“21”) pointed out with the cursor 38 is clicked by the operation of the mouse. Then, the CPU 12 in step S15 directs to display an hour circle 60 on the date in a large scale at the center of the screen of the display unit 28 as shown in FIG. 8.

As described, the hour circle 60 carries the twenty four hour indications 62 from “1” to “24” and their respective indicators 64 provided at the proximity. Along with the enlarged display of the hour circuit 60, groups of the small sized images 66 at the outside of the circumferential edge of the hour circle 60 are displayed at an enlarged scale. At the time, the date indication 52 is viewed in a partially inverted mode as has been clicked, as denoted by 52a.

While the hour circle 60 is explicitly displayed at the center of the display unit 28 as shown in FIG. 8, the date circle 50 of the preceding level may remain appearing in a faded or thin tone with the month circle 40 at the two levels before displayed in a more faded tone than the date circle 50.

This is followed by step S16 for examining whether or not the date circle 50 has been clicked as pointed out by the cursor 38. When it is determined that the date circle 50 has been clicked, the procedure returns to the step S10 where the date circle 50 at the preceding level is display at the center (See FIG. 7). The hour circle 60 that is a lower level indication disappears. When it is determined in step S16 that the date circle 50 has been not clicked, the procedure goes to the step S15 before is shifted to a standby mode.

When an interruption command of “end of retrieval” is received during the above procedure, any operation in the procedure is canceled and the procedure is closed.

Although the circles from the year circle 30 to the hour circle are displayed one by one by the select and click operation in this embodiment described above, they may be displayed at once on the display unit 28.

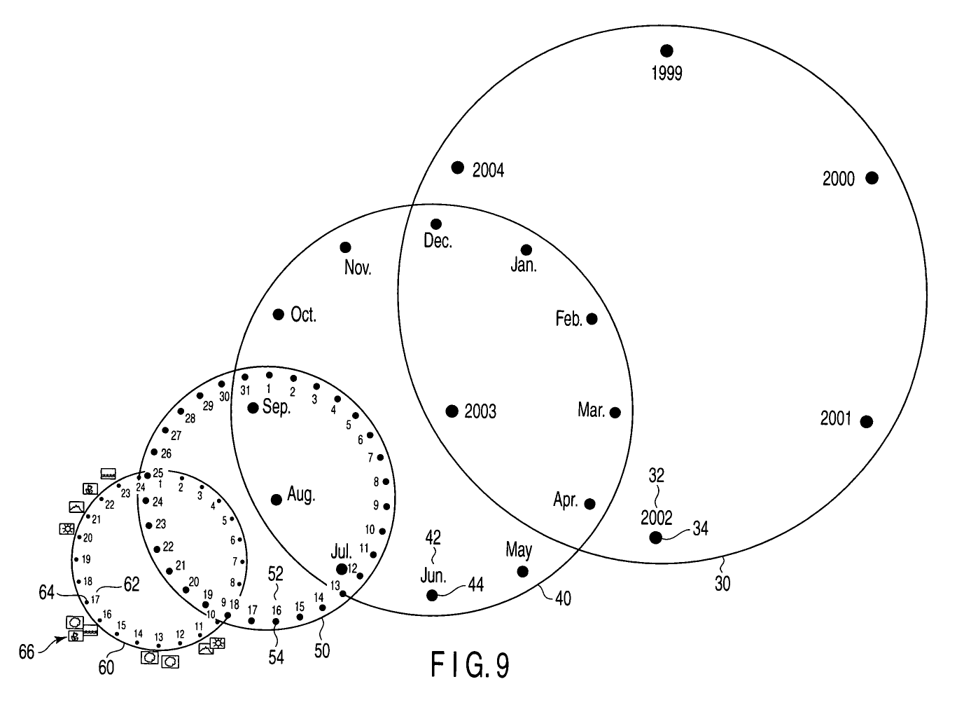

FIG. 9 illustrates an example of displaying at once all the four circles from the year circle to the hour circle.

More particularly, the hour circle 60 as the lowest circle is displayed in the darkest tone while the other circles become thinner in the tone towards the highest. The lower circle appears of which the center is located at the selected indicator on the higher circle. In other words, as the indicators shift from “2003” to “Aug” and “21”, the lower circles appear (from the month circle 40 at the year circle 30 to the date circle 50 and the hour circle 60) as shown in FIG. 9.

In response to the operation of switching a desired switch on the operating unit 14 or clicking a desired icon on the screen of the display unit 28, the CPU 12 can shift the display of one level circle to another circle. For example, when the cursor is dragged to and clicked at any other location than the time circle on the screen or moved towards the outside of the screen, the CPU 12 displays all the time circles at once. When the cursor is clicked at any location in desired one of the time circles on the screen where all the time circles are displayed, the desired time circle appears in a large scale on the center of the screen of the display unit 28.

When the image display apparatus of this embodiment is installed in a camera, the above displaying operation may be triggered by operating the telescopic/wide scroll bar of a zooming control switch. In general, the zooming control switch on the camera is used for zooming up and down the subject to be shot and remains turned off during the playback operation. Therefore, When the zooming control switch is assigned with another function as the display shifting control switch during the playback operation, it can contribute to no increase in the number of the components in the apparatus.

The methods of displaying all the time circles and shifting from one time circle to another are not limited to the above-described methods.

As described, the first embodiment of the present invention allows the time circles indicating year, month, date, and hour to be displayed in layers, one circle over another, as accompanied with groups of small sized picture images at the outside of the circumferential edge of the selected circle. Accordingly, any desired one of the picture images can be retrieved with much ease.

Also, the different time circles can be displayed at once. Moreover, as the time circles are shifted from one to another, a group of the small sized images recorded in a given interval of time can appear. The interval of time or the date and time of shooting is an effective parameter for searching the desired picture images.

While the time circle of interest is displayed over the preceding time circle in an overlapping fashion on one screen by the moving operation of the cursor, its enlarged form appear when the cursor is clicked. This permits the shifting of the time circles from one to another to be conducted in a continuous mode thus ensuring the smooth operation of a user.

### Second Embodiment

The second embodiment of the present invention will now be described.

While the first embodiment allows desired ones of the picture images to be retrieved through viewing their small sized images on the screen, the second embodiment is configured to display the small sized images in a slide show. The slide show is a fashion for automatically displaying a set of the small sized images in a predetermined sequence.

The configuration and the fundamental operation of an image display apparatus according to the second embodiment are identical to those of the first embodiment shown in FIGS. 1 to 9. Like components and steps are denoted by like numerals as those of the first embodiment and will be explained in no more detail. Different components and steps only will be described.

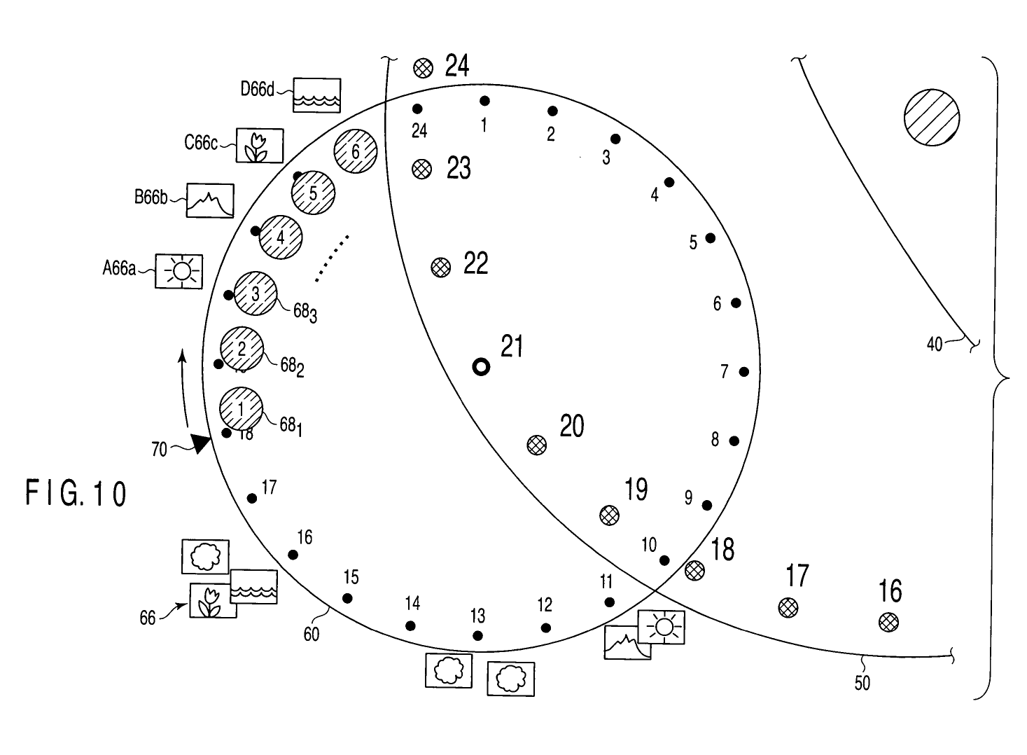

FIG. 10 illustrates the second embodiment of the present invention where groups of the small sized images for a slide show are displayed along the outer edge of the hour circle 60.

As shown in FIG. 10, the small sized images A66a, B66b, C66c, D66d, and so on are displayed along the outer edge of the hour circle 60 for a slide show. The white numerals 1 (68₁), 2 (68₂), 3 (68₃), 4 (68₄), and so on displayed at the inside of the hour circle 60 are provided for explaining the timing for displaying the images in a slide show. Accordingly, they do not appear on the actual screen.

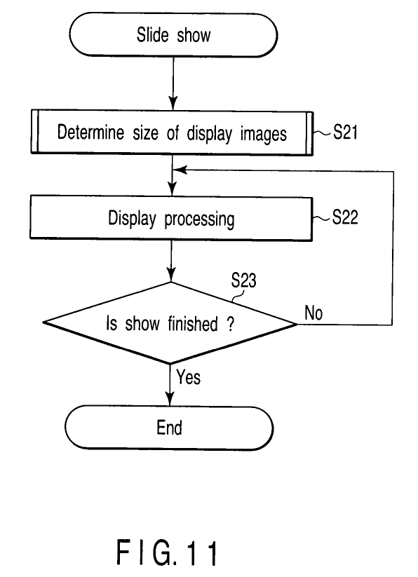

The operation of a slide show in the image display apparatus of the second embodiment will be described referring to a flowchart shown in FIG. 11. The operation of the slide show is controlled by a control program in the CPU 12.

In this embodiment, the slide show is not only display of the images one by one. The slide show allows a series of the images to be displayed in a sequence with its appearing timing lagged while each image being varied in the size from the smallest to the largest and then from the largest to the smallest.

The timing of starting the slide show is initiated by a slide show start button switch on the operating unit 14 being pressed. Alternatively, the slide show may be started as a screen saver after a given period of time during the operation of retrieving the images such as in the first embodiment. In the latter case, the small sized images along the time circle shown currently on the screen such as shown in FIG. 10 are subjected to the slide show.

The timing of shifting one image to another in the slide show is determined with a counter or a timer, not shown, provided in the CPU 12.

When a command to start a slide-show is issued, a sub-routine of “determining the size of images to be displayed” is carried out.

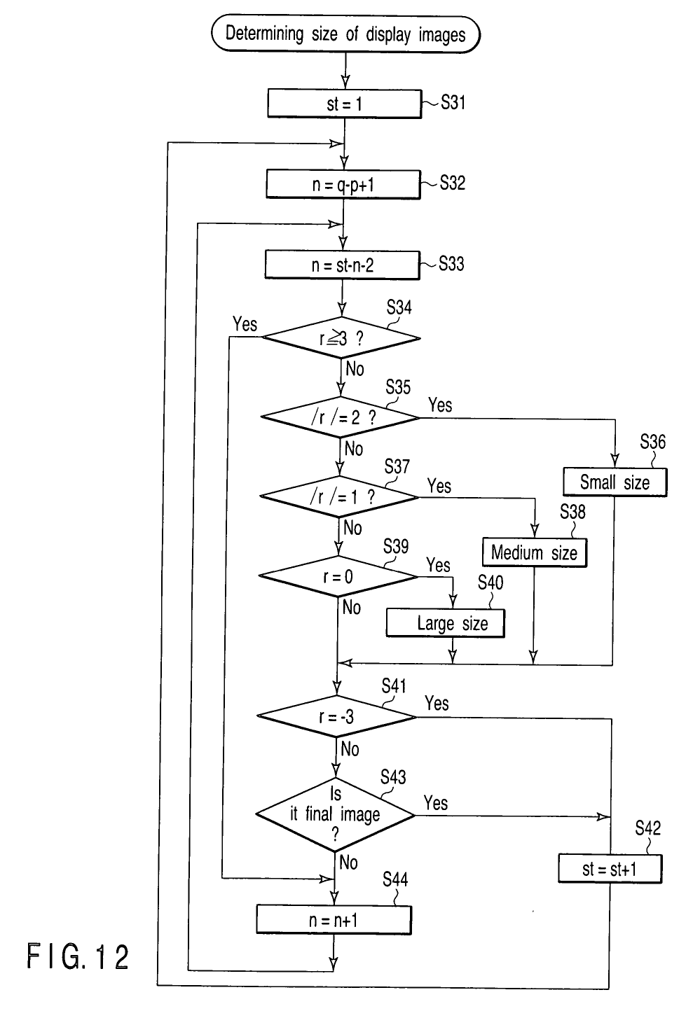

FIG. 12 is a flowchart showing detailed steps for the sub-routine of “determining the size of images to be displayed”.

When the sub-routine starts, in step S31 the counter setting st is initialized. The numbers of counter setting st are (1, 2, 3, . . . ), corresponding to the step numbers 68₁, 68₂, 68₃, 68₄, and so on shown in FIG. 10.

Then, at step S32, a group of the images (the images A, B, C, and D . . . ) to be displayed in the slide show are given temporal new image numbers (n). With respect to image A, image B, image C, image D and so on, temporal new image numbers (n) are set, replacing the original image numbers (q).

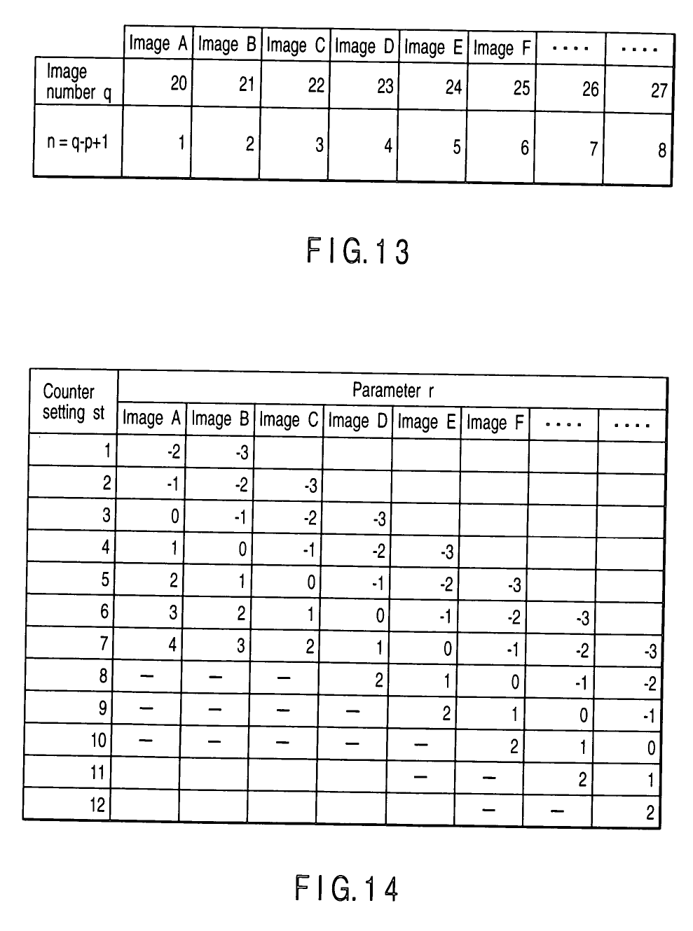

This numbering is intended to start the slide show with the image n while n is calculated from n=q−p+1 where p is the original image number from which the slide show starts. The relationship between the image number q and the image number n is shown in FIG. 13. For example, when the slide show starts with the image A at the number q=20, n=q−19 is established with p=20. Accordingly, the image A is numbered with n=1 and then the image B is numbered with n=2 and so on.

This is followed by step S33 for calculating a parameter r which is for determining the size of the image to be displayed by r=st−n−2. Using the parameter r, the size of the image to be displayed is determined by the steps after S34.

Next, the procedure to determine the size of the image to be displayed in the slide show will now be explained.

FIG. 14 is a table illustrating the relationship between the counter setting st and the parameter r for determining the size of the image to be displayed.

The parameter r shown in FIG. 14 is provided for determining the size of the image to be displayed as explained in steps S34, S35, S37, and S39 in the flowchart of FIG. 12. When the parameter r is 0, the image to be displayed appears in a large size. When the parameter r is 1 or 2, the image appears in a medium size or a small size. If the parameter r is greater or smaller than the range, the image remains not displayed.

The slide show in this embodiment is arranged not to display a set of the images in the same size. In fact, the three, large, medium, and small, sizes of the image are displayed at once as overlapping one another on the screen.

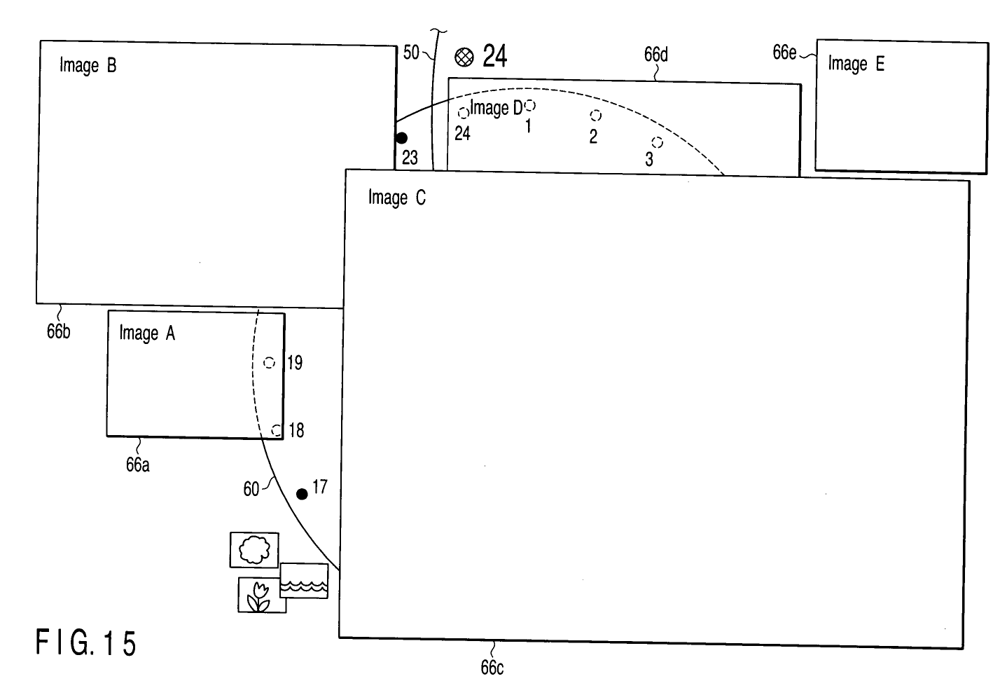

FIG. 15 illustrates an example of displaying some images at the different sizes when the counter setting st shown in FIG. 14 is st=5. In FIG. 15, the largest image (at the large size) is denoted by C66c. Denoted by B66b and D66d are the images at the medium size which are smaller than the image C66c as preceding and succeeding the image C66c respectively. Also, denoted by A66a and E66e are the images at the small size which are smaller than the images B and D as preceding the image B66b and succeeding the image D66d respectively.

The five images A to E are overlapped each other with the images B66b and D66d at the medium size appearing over the images A66a and E66e at the small size. At the top, the image C66c at the large size is displayed over the images B66b and D66d at the medium size. In other words, the image to be displayed at the center appears at the greatest size while its preceding and succeeding images are displayed at a smaller size.

Although the images to be displayed are switched one after another through the operation of expanding or compressing, their display may be timed with fade-in or fade-out operation.

The image to be displayed is expanded or compressed at the same location on the screen. However, if desired, the image to be displayed may appear at the small size, the medium size, and the large size at different locations on the screen. While the images are varied, they may be displayed at the same location at the small, medium, or large size. Display sizes of respective images (A, B, C, . . . ) are determined in step S34 to step S40. The size of each image is determined by the corresponding number r, as shown in FIG. 14. The details are described hereinafter.

It is examined in step S34 whether the parameter r is smaller than three or not. When its parameter r is three or greater, the image is not displayed even at the small size. Then, the procedure jumps to step S44. When the parameters r is smaller than three, the procedure advances to step S35.

It is then examined in step S35 whether the absolute value of the parameter r is two or not. When the absolute value of the parameter r is two, the procedure moves to step S36 for selecting the small size as the display size before advances to step S41. When it is determined in step S35 that the absolute value of the parameter r is not two, the procedure goes to step S37.

It is further examined in step S37 whether the absolute value of the parameter r is one or not. When the absolute value of the parameter r is one, the procedure moves to step S38 for selecting the medium size as the display size before advances to step S41. When it is determined in step S37 that the absolute value of the parameter r is not one, the procedure goes to step S39.

It is still further examined in step S39 whether the absolute value of the parameter r is zero or not. When the absolute value of the parameter r is zero, the procedure moves to step S40 for selecting the large size as the display size before advances to step S41. When it is determined in step S39 that the absolute value of the parameter r is not zero, the procedure skips step S40 and goes to step S41.

It is examined in step S41 whether the parameter r is −3 or not. When the parameter r is −3, the procedure moves to step S42 for incrementing the counter setting st. Then, the procedure returns back to step S32. When it is determined in step S41 that the parameter r is not −3, the procedure goes to step S43.

It is then examined in step S43 whether the image to be displayed is the final one or not in the slide show. The image with the largest number of the image number (q) is the final image. When the image is not the final one, the procedure moves to step S44 for incrementing the counter n. More specifically, the images to be examined for determining the size are shifted from the image A to the image B and the image C and so on. Then, the procedure moves to Step S33. When it is judged at Step S43 that the image is the final one, the procedure jumps to Step S42.

Meanwhile, when all the images need not to be displayed with the counter setting st, the procedure returns to step S22. For example, when the image F shown in FIG. 14 is the final one, the action of determining the size to be displayed actually comes to the end at st=10. Since the further action with st=11 or higher is unnecessary, the procedure goes back to step S22. Through conducting the sub routine described, the table shown in FIG. 14 is created in the CPU 12.

Returning to the flowchart of FIG. 11, in the step S22, based on the table created in the sub-routine of the step S21, a display processing is carried out. The procedure starts in step S22 for subjecting the images at the selected size determined by the sub routine of “determining the size of images to be displayed” in step S21 to the known signal processing actions of the image processor 18 including tone and gray-level adjustment, Y correction, data expansion, and data compression. Then, the images at the selected size are displayed on the display unit 28. The display lasts for a given length of time. For example, the display may last 0.5 second.

It is examined in step S23 whether the slide show is to be terminated or not. When the slide show is to be continued, the procedure returns to step S21 for repeating the described steps. When the end of the slide show is desired, this routine is closed.

As described above, according to the second embodiment, sizes of the image to be displayed are changed as the time passes. The search for desired images can be done with ease during a slide-show.

As described, the operating unit in the first embodiment and the second embodiment are, but not limited to, a mouse. For example, the above operation may be controlled with a touch panel switching on and off to change the display. Also, an array of push-type keys may be used with equal success.

The time circles are not limited to the year circle presenting one year, the month circle representing one month, the date circle representing one day, and the hour circles representing one hour. Any mode of the time circle capable of indicating a given interval of time can be used such as a half-year circle or a week circle.

Also, the time circle at the top on the screen is not limited to a circular shape.

In particular, a program code read from the recording medium may be functioned as a novel feature of the present invention. The recording medium saving the program code therein incorporates a part of the present invention. The program may be saved in an external medium (a CD-ROM) installed in the apparatus or a communication medium over a network system (a LAN or a radio communication network).

Although the time display function and image display function in the image processor 26 is described in the form of a hardware, it may be implemented by a software operated with a CPU 12.

It would be understood that the present invention is not limited to the foregoing embodiments but various changes and modifications are possible without departing from the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image display apparatus comprising:
a time display unit which displays a time circle which is a circular time axis indicating a predetermined length of time in the full turn; and
an image display unit which displays groups of small sized images, which have been recorded at intervals of time in the time circle, at the locations assigned to the intervals of the time circle, wherein
when one of the intervals of time on the time circle is specified, the time display unit displays another time circle which indicates the specified interval of time as a full length of time and of which the center is at the specified interval of time, and
the image display unit displays corresponding ones of the small sized images along the another time circle.

2. An image display apparatus according to claim 1,
wherein the image display unit displays the small sized images along the another time circle in a different mode from of the small sized images along the preceding time circle.

3. An image display apparatus according to claim 1,
wherein the time display unit displays the another time circle which is smaller in the size than the preceding time circle.

4. An image display apparatus according to claim 1,
wherein the image display unit displays the small sized images starting from the oldest of priority recorded in the interval of time.

5. An image display apparatus according to claim 1,
wherein the time display unit displays the another time circle in a larger scale when desired.

6. An image display apparatus according to claim 2,
wherein the time display unit displays the another time circle in a larger scale when desired.

7. An image display apparatus according to claim 3,
wherein the time display unit displays the another time circle in a larger scale when desired.

8. An image display apparatus according to claim 4,
wherein the time display unit displays the another time circle in a larger scale when desired.

9. An image display apparatus according to any of claims 5 to 8, wherein
the time display unit is configured to provide as the time circle at least one selected from a year circle indicating some years as the full length of time and one year as each interval of time, a month circle indicating one year as the full length of time and one month as each interval of time, a date circle indicating one month as the full length of time and one day as each interval of time, and an hour circle indicating one day as the full length of time and one hour as each interval of time.

10. A displaying method for an image display apparatus, comprising:
displaying a time circle which is a circular time axis indicating a predetermined length of time in the full turn;
displaying groups of small sized images, which have been recorded at intervals of time in the time circle, at the locations assigned to the intervals of the time circle;
when one of the intervals of time on the time circle is specified, displaying another time circle which indicates the specified interval of time as a full length of time and of which the center is at the specified interval of time; and
displaying corresponding ones of the small sized images along the another time circle.

11. A displaying method according to claim 10, further comprising:
displaying the another time circle in a larger scale when desired.

12. A computer-readable recording medium having recorded therein a program to cause a computer to execute a displaying method on an image display apparatus, wherein
the display method comprises:
displaying a time circle which is a circular time axis indicating a predetermined length of time in the full turn;
displaying groups of small sized images, which have been recorded at intervals of time in the time circle, at the locations assigned to the intervals of the time circle;
when one of the intervals of time on the time circle is specified, displaying another time circle which indicates the specified interval of time as a full length of time and of which the center is at the specified interval of time; and
displaying corresponding ones of the small sized images along the another time circle.

13. An image display apparatus comprising:
a time display unit which displays a time circle which is a circular time axis indicating a predetermined length of time in the full turn; and
an image display unit which displays groups of small sized images, which have been recorded at intervals of time in the time circle, in an order of time while varying their displaying size with time.

14. An image display apparatus according to claim 13, wherein
the predetermined length of time is at least one selected from one year, one month, and one day.

15. A displaying method for an image display apparatus, comprising:
displaying a time circle which is a circular time axis indicating a predetermined length of time in the full turn; and
displaying groups of small sized images, which have been recorded at intervals of time in the time circle, in an order of time while varying their displaying size with time.
